(19) United States
(12) Patent Application Publication
(10) Pub. No.: US 2022/0161773 A1
(43) Pub. Date: May 26, 2022

(54) ELECTROHYDRAULIC POWER VEHICLE BRAKING SYSTEM

(71) Applicant: Robert Bosch GmbH, Stuttgart (DE)

(72) Inventors: Andreas Weh, Sulzberg (DE); Herbert Vollert, Vaihingen/Enz (DE); Joerg Riethmueller, Heilbronn (DE); Martin Hagspiel, Rettenberg (DE); Michael Wilcox, Charleston, SC (US); Andreas Bresser, Ludwigsburg (DE)

(21) Appl. No.: 17/425,547

(22) PCT Filed: Nov. 30, 2019
(86) PCT No.: PCT/EP2019/083200

§ 371 Date: Jul. 23, 2021

(30) Foreign Application Priority Data
Feb. 7, 2019 (DE) 10 2019 201 536.0

(51) Int. Cl. B60T 13/16

(52) U.S. Cl. CPC B60T 13/167

(57) ABSTRACT

A connection of a piston-cylinder unit of an power brake pressure generator of an electrohydraulic power vehicle braking system to an unpressurized brake fluid reservoir with the aid of a pressure limiting valve and a controllable valve. The pressure limiting valve prevents pressure spikes in the vehicle braking system if inlet valves of hydraulic wheel brakes of the vehicle braking system are closed during a pressure buildup with the aid of the power brake pressure generator. Brake fluid may be drawn in or discharged from the brake fluid reservoir via the controllable valve during a slip control.

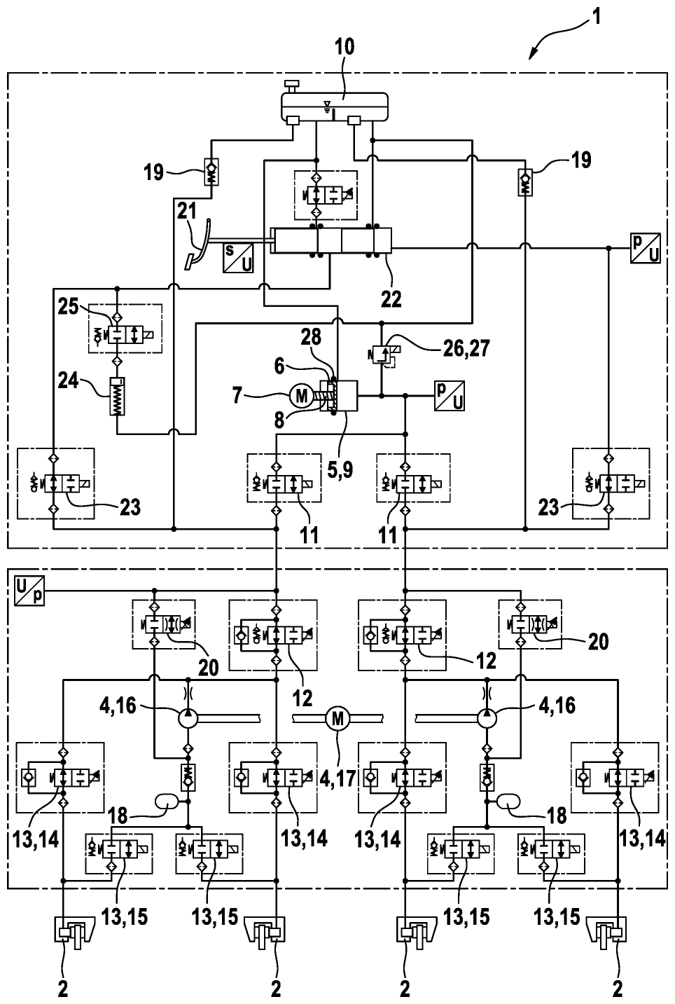

### FIELD

The present invention relates to an electrohydraulic power vehicle braking system.

### BACKGROUND INFORMATION

PCT International Patent Application No. WO 2012/150 120 A1 describes an electrohydraulic power vehicle braking system, which includes a muscle-power master brake cylinder and an electrohydraulic power brake pressure generator. The electrohydraulic power brake pressure generator includes a piston-cylinder unit, whose piston is movable in a cylinder of the piston-cylinder unit via a helical gearing with the aid of an electric motor to generate brake pressure. A service brake application takes place as a power brake application with the aid of a brake pressure buildup by the power brake pressure generator, the master brake cylinder acting as a setpoint generator for the brake pressure. An autonomous power brake application without actuation of the master brake cylinder is also possible. In the case of a defect or a failure of the power brake pressure generator, the vehicle braking system may be actuated by muscle power, using the master brake cylinder.

### SUMMARY

The electrohydraulic power vehicle braking system according to an example embodiment of the present invention includes an electrohydraulic power brake pressure generator, to which hydraulic wheel brakes are connected via inlet valves. The vehicle braking system includes at least one hydraulic wheel brake and preferably multiple hydraulic wheel brakes, an inlet value preferably being assigned to each wheel brake. However, multiple or all wheel brakes may also be connected to one inlet valve.

The vehicle braking system according to an example embodiment of the present invention may include one or multiple brake circuits, each including one or multiple wheel brakes. For a passenger car, the vehicle braking system includes, in particular, two brake circuits, each including two wheel brakes.

A pressure limiting valve limits a pressure in the power brake pressure generator. An impermissibly high hydraulic pressure in the vehicle braking system is avoided thereby, which could damage or destroy the vehicle braking system. In particular, in the case of a rapid and high brake pressure buildup with the aid of the power brake pressure generator up to a permissible maximum pressure of the vehicle braking system, the power brake pressure generator may further increase the brake pressure up to 50% or more above the permissible maximum pressure, due to dynamic effects, if it is shut down upon reaching the permissible maximum pressure and the inlet valves are closed to avoid a locking of vehicle wheels. An opposing energization, by which a reversal of a driving direction of the power brake pressure generator is meant, reduces the exceedance of the permissible maximum pressure in the vehicle braking system, but does not prevent it. The pressure limiting valve according to the present invention avoids the exceedance of the permissible maximum pressure.

Advantageous embodiments and refinements of the present invention are disclosed herein.

In accordance with an example embodiment of the present invention, a controllable valve is provided, for example a solenoid valve, which is arranged hydraulically in parallel to the pressure limiting valve. The pressure limiting valve may be integrated into the controllable valve. With the aid of the controllable valve, it is possible, for example during a slip control, to draw in brake fluid from a brake fluid reservoir using the power brake pressure generator to have sufficient brake fluid available for slip control, or to discharge excess brake fluid for the slip control.

In accordance with an example embodiment of the present invention, the power brake pressure generator includes a piston-cylinder unit, whose piston is sealed by only one piston seal in a cylinder of the piston-cylinder unit. A sealing with the aid of more than one seal is unnecessary, because the pressure limiting valve according to an example embodiment of the present invention limits the maximum pressure in the vehicle braking system. The piston seal surrounds the piston and forms a seal at a circumference between the piston and the cylinder.

All features described in the description and shown in the FIGURE may be implemented individually on its own or, in principle, in any arbitrary combination in exemplary embodiments of the present invention. Designs of the present invention which do not have all features but only one or multiple thereof are, in principle, possible.

### BRIEF DESCRIPTION OF THE DRAWING

The present invention is explained in greater detail below on the basis of one specific embodiment illustrated in the FIGURE. The FIGURE shows a hydraulic circuit diagram of an electrohydraulic power vehicle braking system according to an example embodiment of the present invention.

### DETAILED DESCRIPTION OF EXAMPLE EMBODIMENTS

Vehicle braking system 1 according to the present invention is provided for a passenger car, which includes four hydraulic wheel brakes 2, and is designed as a dual-circuit braking system including two hydraulic wheel brakes 2 for each brake circuit. Other designs are possible, for example a single-circuit braking system or a multi-circuit braking system including more than two brake circuits and/or another number of wheel brakes 2 and/or another assignment of wheel brakes 2 to the brake circuits.

Vehicle braking system 1 includes an electrohydraulic power brake pressure generator 3, including a piston-cylinder unit 5, whose piston 6 is axially movable in a cylinder 9 via a threaded drive 8 or another rotational-translational converter transmission with the aid of an electric motor 7 for generating a brake pressure. Piston-cylinder unit 5 may also be referred to as a plunger unit and piston 6 as a plunger piston.

Wheel brakes 2 are connected to power brake pressure generator 3, specifically to cylinder 9 of piston-cylinder unit 5 of power brake pressure generator 3, via valves, which are referred to here as plunger valves 11, first isolating valves 12 and a brake pressure regulating valve arrangement 13. For the purpose of distribution to the two brake circuits, two plunger valves 11 are situated hydraulically in parallel, two first isolating valves 12 are also situated hydraulically in parallel, and one plunger valve 11 and one first isolating valve 12 are each situated hydraulically in series. With the aid of brake pressure regulating valve arrangement 13, two wheel brakes 2 are each connected to power brake pressure generator 3 via a plunger valve 11 and a first isolating valve 12.

Brake pressure regulating valve arrangement 13 includes an inlet valve 14 and an outlet valve 15 for each wheel brake 2. Wheel brakes 2 are connected to first isolating valves 12 via inlet valves 14, and two wheel brakes 2 are each connected to one inlet valve 14 and one first isolating valve 12 in each brake circuit. Wheel brakes 2 are connected via outlet valves 15 to suction sides of hydraulic pumps 16, which are drivable with the aid of a common electric motor 17. One hydraulic pump 16 is present for each brake circuit, to whose suction sides wheel brakes 2 of the particular brake circuit are connected via outlet valves 15.

Between outlet valves 15 and hydraulic pumps 16, hydraulic accumulators 18 are connected to the suction sides of hydraulic pumps 16 for buffering brake fluid, which flows out of wheel brakes 2 upon an opening of outlet valves 15 during a brake pressure regulation and/or slip control.

Inlet valves 14 and outlet valves 15 form brake pressure regulating valve arrangement 13, with the aid of which the wheel brake pressures in each wheel brake 2 may be controlled individually. Slip control systems, in particular an anti-lock, traction slip and/or vehicle dynamics control system or electronic stability program are possible together with hydraulic pumps 16. The abbreviations ABS, TCS and/or VDC or ESP are commonly used for these slip control systems. Vehicle dynamics control systems and electronic stability programs are also referred to colloquially as anti-skid control systems. Slip control systems of this type are conventional and are not explained in greater detail here.

In addition, the suction sides of hydraulic pumps 16 are each connected to an unpressurized brake fluid reservoir 10 by a check valve 19 and a suction valve 20, so that hydraulic pumps 16 are able to draw in brake fluid from brake fluid reservoir 10 for generating brake pressure or increasing brake pressure. Brake fluid may flow through check valves 19 from the direction of brake fluid reservoir 10 in the direction of suction valves 20 and hydraulic pumps 16.

Vehicle braking system 1 according to the present invention includes a dual-circuit master brake cylinder 22, which may be actuated by a foot brake pedal 21, as a muscle-power brake pressure generator, to which wheel brakes 2 in each brake circuit are each connected via a second isolating valve 23, first isolating valves 12 and inlet valves 14 of brake pressure regulating valve arrangement 13, so that vehicle braking system 1 may also be actuated by muscle power. Second isolating valves 23, first isolating valves 12 and inlet valves 14 are arranged hydraulically in series. Dual-circuit master brake cylinder 22 may include a brake booster, which is not illustrated, and is then referred to as an auxiliary brake pressure generator.

In principle, an actuation of vehicle braking system 1 by external power is provided, a brake pressure being generated with the aid of electrohydraulic power brake pressure generator 3. In the case of a fault or a failure of electrohydraulic power brake pressure generator 3, a brake pressure generation is possible with the aid of hydraulic pumps 16 of the slip control system or optionally with the aid of master brake cylinder 15. Master brake cylinder 15 is used per se as a setpoint generator for the wheel brake pressures to be set in wheel brakes 2 in the case of a functional electrohydraulic power brake pressure generator 3.

In one of the two brake circuits, a pedal travel simulator 24 is connected to master brake cylinder 22 via a simulator valve 25. Pedal travel simulator 24 is a spring-loaded hydraulic accumulator, into which brake fluid may be forced out of master brake cylinder 22 when simulator valve 25 is opened, so that at a power brake application a piston is movable in master brake cylinder 22 when second isolating valves 23 are closed, and foot brake pedal 21 is movable to give the vehicle driver a customary pedal feeling.

If a high wheel brake pressure is rapidly generated with the aid of electrohydraulic power brake pressure generator 3 to initiate a brake application, the slip control system closes inlet valves 14 of wheel brakes 2 when a locking limit is reached or exceeded, and vehicle wheels braked with the aid of wheel brakes 2 lock or begin to lock. A typical wheel brake pressure in wheel brakes 2 at the beginning of the locking of vehicle wheels on a dry road is, for example, between approximately 90 bar and 120 bar and is reached within, for example, approximately 150 milliseconds to 200 milliseconds. Upon the closing of inlet valves 14, an energizing of electric motor 7 is interrupted, which may also be construed as a deactivation of power brake pressure generator 3. Due to dynamic effects, piston 6 of piston-cylinder unit 5 of power brake pressure generator 3 does not immediately stop when the current feed of electric motor 7 is switched off, but instead piston 6 continues to move a short distance farther in cylinder 9 before it comes to a stop.

In a typical pressure buildup gradient of some 10,000 bar/second, a brake pressure in cylinder 9 of piston-cylinder unit 5 of electrohydraulic power brake pressure generator 3 would increase by at least 80 bar within 8 to 10 milliseconds, due to the advancing of piston 6 after the current feed of electric motor 7 is switched off, by which a permissible maximum pressure in vehicle braking system 1 would be exceeded, and vehicle braking system 1 could become damaged or destroyed. 8 to 10 milliseconds are a typical time which elapses from a detection of a pressure increase in cylinder 9 with the aid of a pressure sensor until inlet valves 14 close. Even if electric motor 7 is energized against its rotational direction during the brake pressure generation upon the closing of inlet valves 14, to bring pistons 6 to a stop as quickly as possible, the brake pressure increases impermissibly and may damage or destroy vehicle braking system 1.

A controllable valve, for example a solenoid valve, opens too slowly to limit a rise in the pressure in cylinder 9 of piston-cylinder unit 5 of electrohydraulic power brake pressure generator 3 to a permissible value, for which reason the present invention provides an, in particular, mechanical pressure limiting valve 26, with the aid of which cylinder 9, or generally speaking power brake pressure generator 3, is connected to brake fluid reservoir 10. An opening pressure of pressure limiting valve 26 is preferably settable and is set to the permissible maximum pressure of vehicle braking system 1, by which an exceedance of the permissible maximum pressure of vehicle braking system 1 is avoided.

In the illustrated and described specific embodiment, pressure limiting valve 26 is additionally designed as a solenoid valve, i.e., generally as a controllable valve 27, so that it may also be opened if the opening pressure is not reached.

Because pressure limiting valve 26 prevents impermissibly high pressure spikes, a sealing of piston 6 in cylinder 9 of piston-cylinder unit 5 of electrohydraulic power brake pressure generator 3 makes do with one piston seal 28. According to the present invention, piston 6 therefore includes only one piston seal 28. Piston seal 28 is a sealing ring, in particular an axial sealing ring or a quad ring, which surrounds piston 6 and forms a seal at a circumference between piston 6 and cylinder 9.

In the drawing, pressure limiting valve 26 is integrated into controllable valve 27, or pressure limiting valve 26 is simultaneously designed as controllable valve 27. For example, a controllable valve 27, which is separate from pressure limiting valve 26, is also possible, which is situated hydraulically in parallel to pressure limiting valve 26 (not illustrated).

During a slip control with the aid of inlet valves 14 and outlet valves 15 of brake pressure regulating valve arrangement 13, in particular when driving hydraulic pumps 16 with the aid of electric motor 7, controllable valve 27 may be opened, so that power brake pressure generator 3 may force brake fluid, which flows out of wheel brakes 2 upon the opening of outlet valves 15, into brake fluid reservoir 10 in the one or an opposite direction by moving piston 6 in cylinder 9 of piston-cylinder unit 5, or conversely may draw in brake fluid out of brake fluid reservoir 10 for the slip control. Controllable valve 27 is therefore designed to be flowed through in both directions.

For example, if a pressure of 120 bar prevails in wheel brakes 2 upon an opening of outlet valves 15 during a slip control, brake fluid flows at this pressure out of wheel brakes 2 into hydraulic accumulator 18. If master brake cylinder 22 is actuated, no brake fluid is able to flow through master brake cylinder 22 into unpressurized brake fluid reservoir 10. The pressure may be lowered by opening controllable valve 27 instead of by the return travel of piston 6 in cylinder 9 of piston-cylinder unit 5 of power brake pressure generator 3. This also has the advantage that one piston seal 28 is sufficient for sealing piston 6 in cylinder 9, and multiple piston seals 28 are not necessary. With only one piston seal 28, cylinder 9 may also be provided with a shorter design, which results in a smaller installation space of a brake pressure control unit including piston-cylinder unit 5. This is an advantage for installation into an engine compartment of a motor vehicle and increases an accident safety because the danger is reduced that a combustion engine of a motor vehicle strikes the transversely situated cylinder 9 of piston-cylinder unit 5 if the combustion engine is pushed in the direction of a passenger compartment by the accident. The brake pressure control unit is normally fastened to a so-called splashboard of the motor vehicle and should therefore not be pushed in the direction of the passenger compartment in an accident.

In the described and illustrated specific embodiment of the present invention, plunger valves 11, first isolating valves 12, inlet valves 16, outlet valves 17, suction valves 20, second isolating valves 23, simulator valve 25 and controllable valve 27 are 2/2-way solenoid valves, first isolating valves 12, inlet valves 16 and second isolating valves 23 being open in their de-energized basic positions, and plunger valves 11, outlet valves 17, suction valves 20, simulator valve 25 and controllable valve 27 are closed in their de-energized basic positions. Other designs of the valves are not ruled out. For example, a combination of inlet valves 14 and outlet valves 15 into 3/2-way solenoid valves is also possible (not illustrated).

1-8. (canceled)

9. An electrohydraulic power vehicle braking system, comprising:
an electrohydraulic power brake pressure generator to which at least one hydraulic wheel brake is connected via an inlet valve;
wherein the power brake pressure generator includes a pressure limiting valve, which limits a pressure in the power brake pressure generator.

10. The electrohydraulic power vehicle braking system as recited in claim 9, wherein the power brake pressure generator includes a controllable valve: (i) into which the pressure limiting valve is integrated, or (ii) with respect to which the pressure limiting valve is situated in a hydraulically parallel manner.

11. The electrohydraulic power vehicle braking system as recited in claim 9 wherein an opening pressure of the pressure limiting valve is settable.

12. The electrohydraulic power vehicle braking system as recited in claim 9, wherein the pressure limiting valve and the controllable valve connect the power brake pressure generator to an unpressurized brake fluid reservoir.

13. The electrohydraulic power vehicle braking system as recited in claim 9, wherein the power brake pressure generator includes a piston-cylinder unit, whose piston is sealed by only one piston seal in a cylinder of the piston-cylinder unit.

14. The electrohydraulic power vehicle braking system as recited in claim 9, wherein the vehicle braking system includes a muscle-force or auxiliary brake pressure generator, using which the at least one wheel brake is actuatable.

15. A method for operating an electrohydraulic vehicle braking system, the electrohydraulic braking system including an electrohydraulic power brake pressure generator to which at least one hydraulic wheel brake is connected via an inlet valve, wherein the power brake pressure generator includes a pressure limiting valve, which limits a pressure in the power brake pressure generator, and wherein the power brake pressure generator includes a controllable valve: (i) into which the pressure limiting valve is integrated, or (ii) with respect to which the pressure limiting valve is situated in a hydraulically parallel manner, and wherein the vehicle braking system includes a slip control system, the method comprising:
temporarily opening the controllable valve during a slip control.

16. The method as recited in claim 15, wherein the power brake pressure includes a piston-cylinder unit, and the method further comprises a piston of the piston-cylinder unit moving while the controllable valve is open.
